(19) United States
(12) Patent Application Publication
(10) Pub. No.: US 2017/0080695 A1
(43) Pub. Date: Mar. 23, 2017

(54) LAMINATING APPARATUS AND LAMINATING METHOD USING THE SAME

(71) Applicant: Samsung Display Co., Ltd., Yongin-si (KR)

(72) Inventor: Tae Min Kang, Yongin-si (KR)

(21) Appl. No.: 15/371,564

(22) Filed: Dec. 7, 2016

Related U.S. Application Data
(62) Division of application No. 14/020,273, filed on Sep. 6, 2013.

(30) Foreign Application Priority Data
May 2, 2013 (KR) 10-2013-0049526

(51) Int. Cl. B32B 37/10; B32B 37/18; B32B 38/00; B32B 37/06

(52) U.S. Cl. CPC B32B 37/10; B32B 37/06; B32B 37/18; B32B 38/004; B32B 2250/03; B32B 2309/68

(57) ABSTRACT

Provided are a laminating apparatus and a laminating method using the same. In an aspect, the laminating apparatus includes a stage, a heating bar, and a press part. In an aspect, the laminating may be performed in a state where the donor film is closely attached to the substrate to prevent defects of the donor film from occurring during the laminating, thereby improving reliability of the laminating apparatus.

### INCORPORATION BY REFERENCE TO ANY PRIORITY APPLICATIONS

This application is a divisional of U.S. patent application Ser. No. 14/020,273, filed Sep. 6, 2013, which claims priority under 35 U.S.C. §119 of Korean Patent Application No. 10-2013-0049526, filed on May 2, 2013, the contents of which are hereby incorporated by reference in their entireties.

### BACKGROUND

Field

This disclosure relates to a laminating apparatus and a laminating method using the same, and more particularly, to a laminating apparatus having improved reliability in a laminating process and a laminating method using the same.

Description of the Related Technology

Laser-induced thermal transfer is a thin film formation method in which laser light is emitted onto a donor film including a photothermal conversion layer and a transfer layer. The photothermal conversion layer converts the laser light into heat energy and then, the transfer layer is transferred onto an acceptor substrate to form a pattern. Laser-induced thermal transfer is mainly used for forming an organic film of an organic light emitting device.

Such laser-induced thermal transfer is performed in a state where a donor film and an acceptor substrate are closely attached to align the donor film with the acceptor substrate. The acceptor substrate may be disposed between the donor film and a lower film by a laminating process before the laser-induced thermal transfer process is performed. When the donor film is incompletely attached to the acceptor substrate during the laminating process, the transfer layer and the acceptor substrate may be misaligned with each other. When the laminating process is performed in a misaligned state, an outgas may permeate between the donor film and the acceptor substrate contaminating the transfer layer and deteriorating reliability.

### SUMMARY

The present disclosure provides a laminating apparatus having improved reliability in a laminating process and a laminating method using the same.

Some embodiments provide laminating apparatuses including: a stage configured to accept a lower film, a substrate disposed on a central area of the lower film, and a donor film, said donor film configured to be disposed on the central area of the lower film and an edge area surrounding the central area to cover the lower film and the substrate; a heating bar configured to apply pressure and heat to the donor film disposed on the edge area and configured to thermo-compressively bond the donor film and the lower film, thereby sealing the substrate by the donor film and the lower film; and a press part configured to press a top surface of the donor film to closely attach a bottom surface of the donor film to a top surface of the substrate.

In some embodiments, the laminating apparatuses may further include a coupling part disposed between the press part and the heating bar, the coupling part having a first end connected to the press part and a second end connected to the heating bar to couple the press part to the heating bar so that the press part is mechanically interlocked with the heating bar.

In other embodiments, the coupling part may be configured to set an initial position of each of the heating bar and the press part so that a distance between a bottom surface of the press part and the top surface of the donor film is less than that between a bottom surface of the heating bar and the top surface of the donor film.

In still other embodiments, the coupling part may include an elastic member configured to be deformed by a force provided from the heating bar and configured to apply an elastic force to the press part.

In some embodiments, the elastic member may include a plate spring or a coil spring. In some embodiments, the elastic member may include a plate spring and a coil spring.

In yet other embodiments, the coupling part may include: a guiding bar extending in a direction perpendicular to a top surface of the press part; a slider extending from the heating bar, the slider being coupled to the guiding bar so the slider is vertically movable; and a head part disposed on an upper end of the guiding bar to prevent the guiding bar from being separated from the slider.

In further embodiments, the laminating apparatuses may further include an elastic member disposed between the slider and the press part, the elastic member configured to be deformed by a force applied from the slider and configured to apply an elastic force to the press part.

In some embodiments, the elastic member may include a plate spring or a coil spring. In some embodiments, the elastic member may include a plate spring and a coil spring.

In some embodiments, the press part may further include a protrusion disposed along an edge of a bottom surface of the press part protruding from a bottom surface of the press part in a direction of the stage.

In some embodiments, the press part may have a shape corresponding to that of the central area.

In some embodiments, the laminating apparatuses may further include: a vacuum chamber configured to accept the lower film, the substrate, the donor film, heating bar, and the press part; a vacuum pump vacuum for exhausting the inside of the vacuum chamber; and a vent part for venting the inside of the vacuum chamber.

In some embodiments, the stage may be configured to accept the donor film when the donor film includes an organic light emitting material for forming a light emitting layer of an organic light emitting device as a transfer layer.

In some embodiments, the stage is configured to accept the donor film when the donor film may have a square shape, and the heating bar may include four heating bars respectively corresponding to four sides of the donor film.

In other embodiments, laminating methods include: providing a laminating apparatus, said apparatus comprising: a stage, a heating bar, and a press part; successively disposing a lower film, a substrate, and a donor film on the stage; applying heat and pressure using the heating bar to the lower film and an edge of the donor film to thermo-compressively bond the donor film and the lower film so that the substrate is sealed by the lower film and the donor film; and pressing a top surface of the donor film by using the press part so that the thermo-compressive bonding is performed in a state where the donor film is closely attached to the substrate.

In some embodiments, the pressing of the top surface of the donor film by using the press part may be performed for a time including a time for which the heating bar performs the thermo-compressive bonding.

In other embodiments, the pressing of the top surface of the donor film by using the press part may be performed from a starting time of the thermo-compressive bonding of the heating bar to an ending time of the thermo-compressive bonding.

In still other embodiments of the laminating methods, the apparatus may further include a vacuum chamber: where the lower film, the substrate, the donor film, heating bar, and the press part may be disposed the vacuum chamber; vacuum-exhausting the vacuum chamber to make the inside of the vacuum chamber in a vacuum state between the successively disposing of the lower film, the substrate, and the donor film and the thermo-compressively bonding of the donor film and the lower film; and venting the vacuum chamber so that the donor film is attached to the substrate after the pressing of the top surface of the donor film.

In some embodiments, contamination of the donor film and transfer layer can be prevented since the lamination is performed in a state where donor film is closely attached to the substrate. As a result, defect generated at the donor film while laminating can be prevented and the laminating process may be improved in reliability.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a cross-sectional view of a laminating apparatus according to an embodiment;

FIG. 2 is a plan view of a lower film disposed on a stage;

FIG. 3 is a cross-sectional view of a laminating target film disposed on the stage;

FIGS. 4A to 4E are cross-sectional views illustrating a laminating process according to an embodiment;

FIG. 5 is a cross-sectional view of a laminating apparatus according to another embodiment;

FIG. 6 is a plan view of a press part having a protrusion according to another embodiment;

FIG. 7 is a cross-sectional view of the press part of FIG. 6;

FIGS. 8A to 8E are cross-sectional views illustrating a laminating process according to another embodiment; and

FIGS. 9A to 9E are cross-sectional views illustrating a laminating process according to further another embodiment.

### DETAILED DESCRIPTION

Hereinafter, a laminating apparatus and method according to an embodiment will be described with reference to the accompanying drawings. In the figures, the dimensions of layers and regions may be exaggerated or reduced for clarity of illustration. Like reference numerals refer to like elements throughout. It will be understood that when an element such as a layer, film, region, or substrate is referred to as being “on” another element, it can be directly on the other element or intervening elements may also be present. Also, although one surface of any component is illustrated in a flat shape, the present embodiments are not limited thereto.

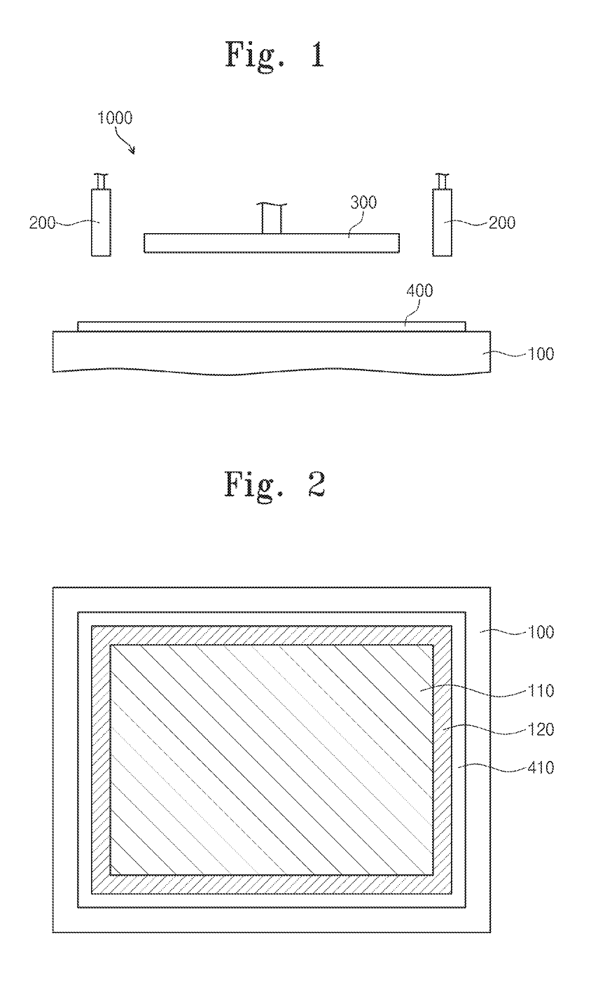

FIG. 1 is a cross-sectional view of a laminating apparatus according to an embodiment.

Referring to FIG. 1, a laminating apparatus 1000 according to an embodiment includes a stage 100, a heating bar 200, a press part 300, and a laminating target film 400. In some embodiments, the laminating target film 400 to be laminated is disposed on a top surface of the stage 100. In some embodiments, the heating bar 200 is disposed above an edge of the laminating target film 400, and the press part 300 is disposed above a central portion of the laminating target film 400.

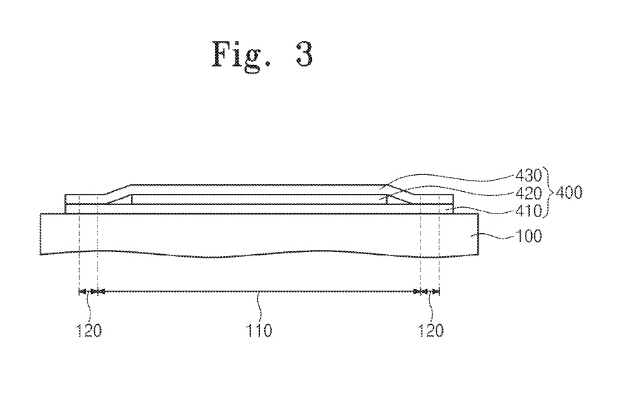

FIG. 2 is a plan view of a lower film disposed on the stage. FIG. 3 is a cross-sectional view of the laminating target film disposed on the stage. Referring to FIGS. 2 and 3, the laminating target film 400 includes a lower film 410, a substrate 420, and a donor film 430. The lower film 410 includes a central area 110 and an edge area 120.

In some embodiments, the stage 100 may be rectangular and formed to have a flat top surface.

In some embodiments, the lower film 410 is disposed on the stage 100. In some embodiments, the central area 110 is defined as a rectangular shape including a central portion of the lower film 410, and the edge area 120 surrounds the central area 110. For example, each of the central area 110 and the edge area 120 may have a modified shape.

In some embodiments, the substrate 420 is disposed on the central area 110 of the lower film 410. In some embodiments, the donor film 430 is disposed on the substrate 420 to cover the substrate 420 and the edge area 120 of the lower film 410. Thus, a top surface of the substrate 420 and a bottom surface of the donor film 430 contact each other on the central area 110. However, the top surface of the substrate 420 and the bottom surface of the donor film 430 do not contact each on the edge area 120.

In some embodiments, the donor film 430 is used when a thin film pattern is formed on the substrate 420 by a laser-induced thermal transfer method. In some embodiments, the donor film 430 includes a base substrate (not shown), a photothermal conversion layer (not shown), and a transfer layer (not shown). In some embodiments, the laser-induced thermal transfer method is a thin film formation method in which laser light is incident into the donor film 430 to convert the laser light into heat through the photothermal conversion layer, thereby transferring the transfer layer onto the substrate 420. In some embodiments, the transfer layer of the donor film 430 may be formed of an organic light emitting material that forms a light emitting layer of an organic light emitting device.

In some embodiments, the substrate 420 is used for manufacturing a display panel of an organic light emitting display device. In some embodiments, the transfer layer of the donor film 430 is transferred onto the substrate 420. In some embodiments, the substrate 420 may include a light emitting pattern defining a position on which the transfer layer including the organic light emitting material is transferred.

In some embodiments, the lower film 410 is provided for fixing the donor film 430 to the substrate 420 when the laminating target film 400 is moved from laminating process or the laminating apparatus 1000 to the laser-induced thermal transfer device (not shown) by closely attaching the donor film 430 to the substrate 420. In some embodiments, the substrate 420 is disposed between the lower film 410 and the donor film 430, and the laminating process is performed to fix the donor film 430 to the substrate 420.

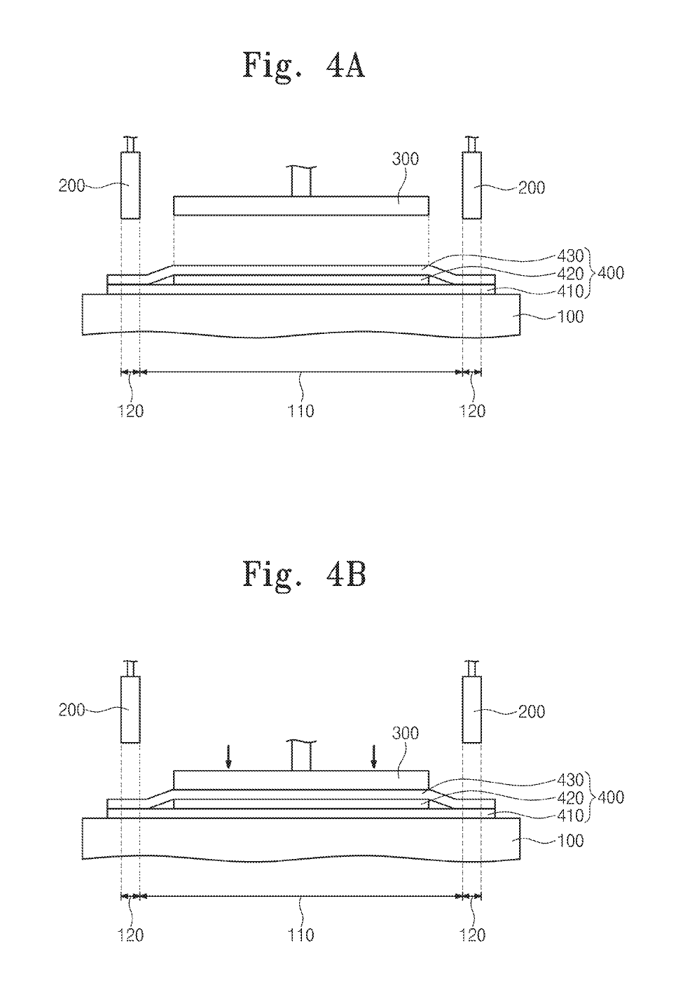

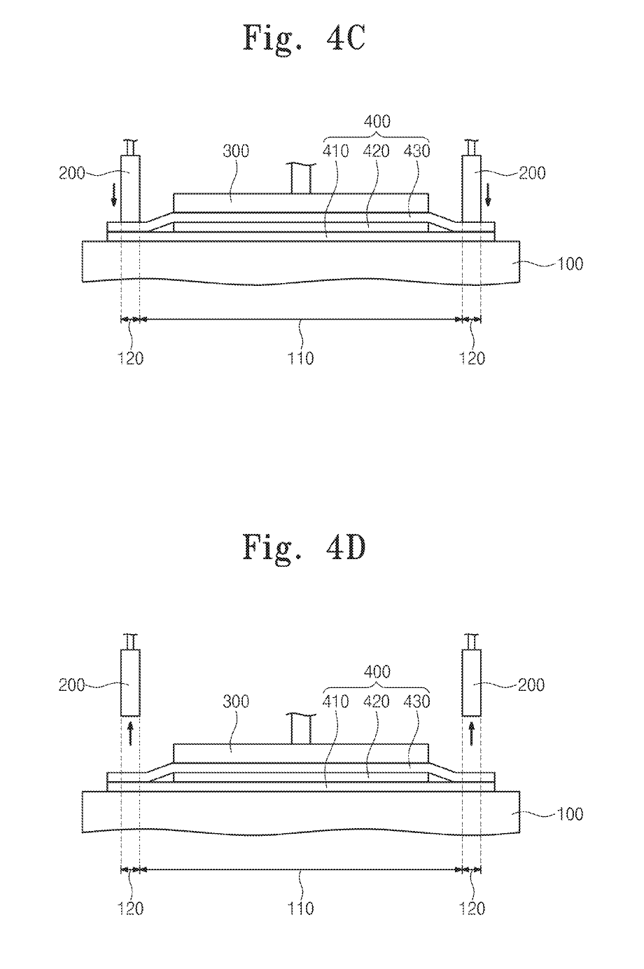

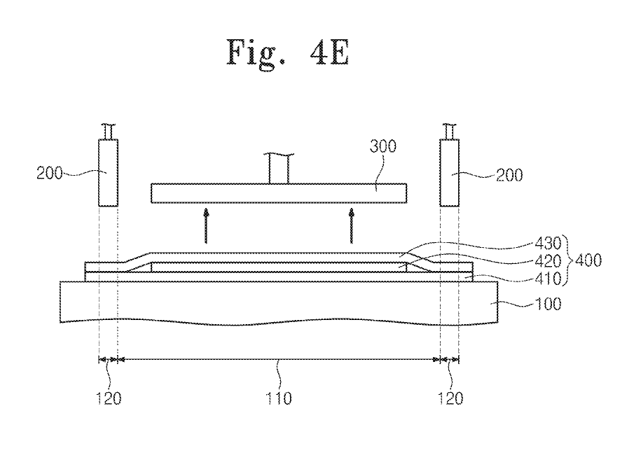

FIGS. 4A to 4E are cross-sectional views illustrating the laminating process according to an embodiment. In some embodiments, the laminating process includes disposing the laminating target film 400, pressing by the press part 300, thermo-compressively bonding by the heating bar 200, collecting the heating bar 200, and collecting the press part 300.

FIG. 4A is a cross-sectional view illustrating a process of disposing the laminating target film according to an embodiment. Referring to FIG. 4A, the laminating target film 400 is disposed on the top surface of the stage 100. In some embodiments, the heating bar 200 and the press part 300 are disposed above the laminating target film 400 and spaced a predetermined distance from the laminating target film 400. Here, the positions of the heating bar 200 and the press part 300 before the laminating process starts may be defined as an initial position.

In some embodiments, the heating bar 200 includes a heating part (not shown) generating heat with applied current. When the lower film 410 and the donor film 430 are thermo-compressively bonded, heat generated from the heating part may be provided to the lower film 410 and the donor film 430.

In some embodiments, an upper portion of the heating bar 200 may be connected to a first moving part (not shown) to ascend or descend by the first moving part.

In some embodiments, the heating bar 200 may have a close loop shape disposed along the edge area 120. For example, the heating bar 200 may be modified in shape. In some embodiments, the heating bar 200 may be divided into four heating bars respectively corresponding to each side of the donor film 430.

In some embodiments, the press part 300 has a flat bottom surface and is parallel to a top surface of the stage 100. In some embodiments, the press part 300 may have a shape corresponding to that of the central area 110. For example, the press part 300 may be modified in shape. In some embodiments, the bottom surface of the press part 300 may be enough to allow the press part 300 to press the top surface of the donor film 430 so that the top surface of the substrate 420 is closely attached to the bottom surface of the donor film 430.

In some embodiments, an upper portion of the press part 300 is connected to a second moving part (not shown) to ascend or descend in a vertical direction with respect to the top surface of the substrate 420 by the second moving part.

Although the figure illustrates as if the top surface of the substrate 420 and the bottom surface of the donor film 430 are completely closely attached to each other, a separated region may exist between the top surface of the substrate 420 and the bottom surface of the donor film 430. Thus, spaces may be formed in the separated region.

FIG. 4B is a cross-sectional view illustrating a pressing process of the pressing part according to an embodiment.

Referring to FIG. 4B, the press part 300 descends toward the substrate 420 by the second moving part (not shown) to contact the donor film 430. Thereafter, the press part 300 presses the donor film 430 to closely attach the bottom surface of the donor film 430 to the top surface of the substrate 420.

FIG. 4C is a cross-sectional view illustrating a thermo-compressive bonding process of the heating bar according to an embodiment. Referring to FIG. 4C, in the state where the press part 300 presses the top surface of the donor film 430, the heating bar thermo-compressively bonds the donor film 430 and the lower film 410.

In some embodiments, the heating bar 200 may be descended by the first moving part to contact the top surface of the donor film 430. Thereafter, the heating bar 200 applies heat and pressure to the top surface of the donor film 430 to thermo-compressively bond the donor film 430 and the lower film 410 which are disposed on the edge area 120. In some embodiments, the edge area 120 has a shape surrounding the central area 110. Thus, the donor film 430 and the lower film 410 form a close loop along the edge area 120 and are thermo-compressively bonded. As a result, the substrate 420 may be sealed by the donor film 430 and the lower film 410 and then laminated.

Since the laminating process is performed in the state where the press part 300 closely attaches the donor film 430 to the substrate 420, it prevents a space form being formed between the substrate 420 and the donor film 430. Particularly, when the donor film 430 and the lower film 410 are thermo-compressively bonded by the heating bar 200, an outgas may be generated. Here, the press part 300 closely attaches the donor film 430 to the substrate 420 to prevent the donor film 430 from being separated from the substrate 420 due to the outgas permeating between the press part 300 and the donor film 430. As described above, when the donor film 430 is closely attached to the substrate 420, it may prevent defects of the donor film 430 due to the contact between the donor film 430 and the substrate 420 in a state where the donor film 430 and the substrate 420 are misaligned with each other. As a result, the laminating process may be improved in reliability.

FIG. 4D is a cross-sectional view illustrating a process of collecting the heating bar according to an embodiment. Referring to FIG. 4D, when the heating bar 200 ascends by the first moving part (not shown) in the state where the press part 300 presses the top surface of the donor film 430, the bottom surface of the heating bar 200 and the top surface of the donor film 430 on the edge region 120 are separated from each other. In some embodiments, the press part 300 continuously applies a pressure to the top surface of the donor film 430 to closely attach the donor film 430 to the substrate 420, thereby preventing the bottom surface of the donor film 430 from being separated from the top surface of the substrate 420 while the heating bar 200 ascends. Thereafter, the heating bar 200 further ascends to reach the same position as the initial position.

FIG. 4E is a cross-sectional view illustrating a process of collecting the press part in the laminating apparatus according to an embodiment. Referring to FIG. 4E, the press part 300 ascends by the second moving part (not shown) to reach the same position as the initial position.

Although the press part 300 presses the top surface of the donor film 430 for a time including a time for which the thermo-compressive bonding of the heating bar 200 is performed in FIGS. 4A to 4E, this is merely an example. Thus, the present embodiments are not limited thereto. For example, the time for which the press part 300 applies the pressure may be changed. For example, the press part 300 may press the top surface of the donor film 430 from a starting time of the thermo-compressive bonding of the heating bar 200 to an ending time of the thermo-compressive bonding.

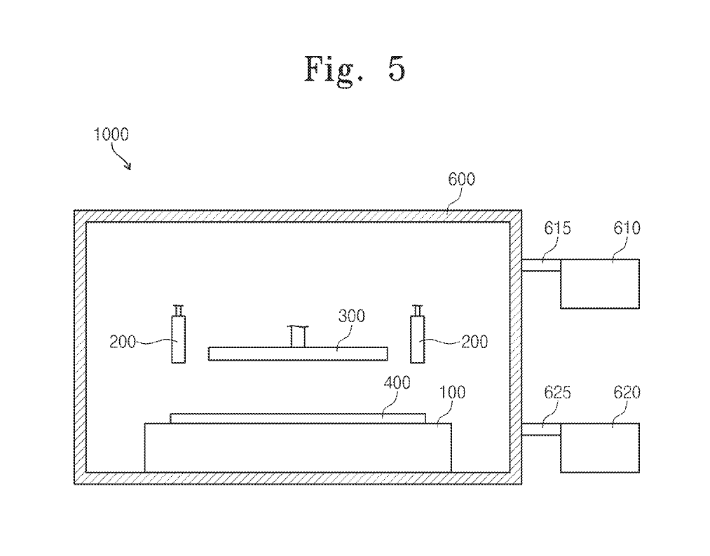

FIG. 5 is a cross-sectional view of a laminating apparatus according to another embodiment. Referring to FIG. 5, the laminating apparatus 1000 further includes a vacuum chamber 600, a pump part 610, and a vent part 620. In some embodiments, the stage 100, the heating bar 200, the press part 300, and the laminating target film 400 are disposed within the vacuum chamber 600. In some embodiments, the pump part 610 and the vent part 620 are disposed outside the vacuum chamber 600.

In some embodiments, the stage 100 is disposed in a lower side of the inside of the vacuum chamber 600. In some embodiments, the laminating target film 400 is disposed on the top surface of the stage 100. In some embodiments, the heating bar 200 is disposed above an edge of the laminating target film 400. In some embodiments, the press part 300 is disposed above a central portion of the laminating target film 400. In some embodiments, the heating bar 200 is connected to the first moving part (not shown), and the press part 300 is connected to the second moving part (not shown) to ascend or descend within the vacuum chamber 600.

In some embodiments, the pump part 610 is connected to the inside of the vacuum chamber 600 through a pump tube 615, and the vent part 620 is connected to the inside of the vacuum chamber 600 through a vent tube 625. In some embodiments, the pump part 610 vacuum-exhausts air within the sealed vacuum chamber 600 through the pump tube 615 to make the inside of the vacuum chamber 600 in a vacuum state. In some embodiments, the vacuum state may not be a state in which the air is completely exhausted, but a state having a vacuum degree less than high vacuum (about 10e-6 torr). In some embodiments, the vent part 620 supplies air or nitrogen gas into the vacuum chamber 600 having the vacuum state through the vent tube 625 to make an inner pressure of the vacuum chamber 600 to a pressure equal to the atmospheric pressure.

In some embodiments, the laminating process may further include vacuum-exhausting the air within the vacuum chamber 600 by using the pump part 610 to make the inside of the vacuum chamber 600 to a high-vacuum state between the disposing of the laminating target film 400 and the laminating. In some embodiments, the high-vacuum state may be maintained to maintain the inside of the vacuum chamber 600 at a pressure less than that of the outside of the vacuum chamber 600 when the vacuum-exhaust is completed. Here, when the laminating is performed to laminate the substrate 420 through the donor film 430 and the lower film 410, a space between the donor film 430 and the lower film 410 may become in a vacuum state having the same vacuum degree as the inside of the vacuum chamber 600. Then, the air or nitrogen gas is supplied into the vacuum chamber 600 through the vent part 620 to vent the inside of the vacuum chamber 600. When the vent of the inside of the vacuum chamber 600 is completed, the outside of the laminating target film 400 may be become to the atmospheric pressure having a high pressure. Here, since the inside of the laminating target film 400 is in the vacuum state, a strong pressure is generated inward from the outside of the laminating target film 400 to attach the donor film 430, the substrate 420, and the lower film 410 to each other.

In some embodiments, the donor film 430 and the substrate 420 of the attached laminating target film 400 may be attached to each other by the vacuum to prevent the donor film 430 from being separated from the substrate 420 and prevent the defects of the donor film 430 due to the contact between the donor film 430 and the substrate 420 in the state where the donor film 430 and the substrate 420 are misaligned with each other from occurring, thereby improving reliability of a rework process.

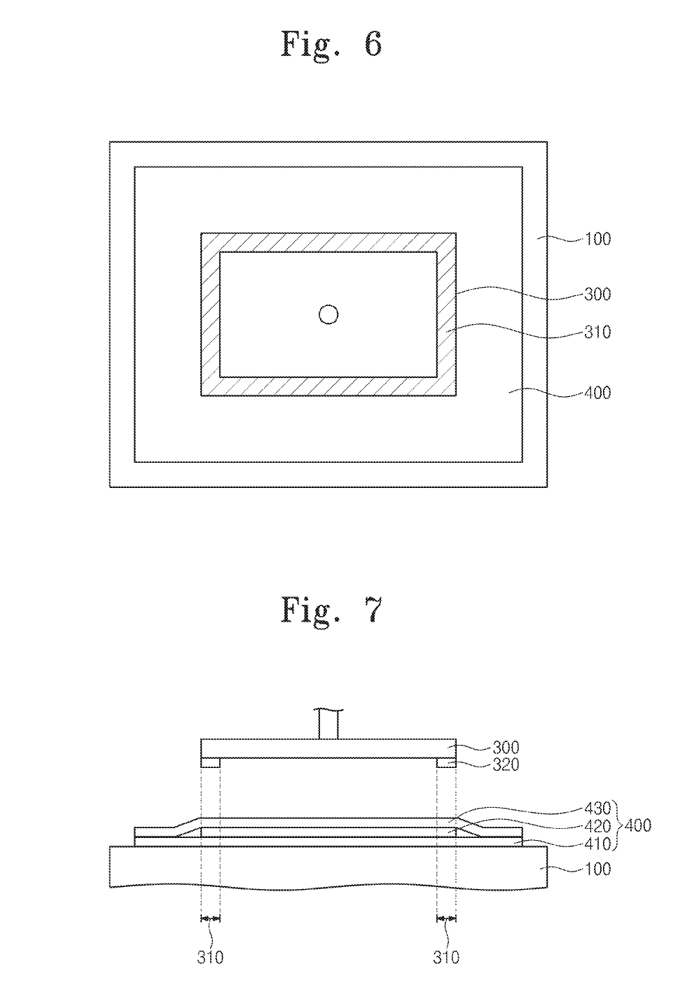

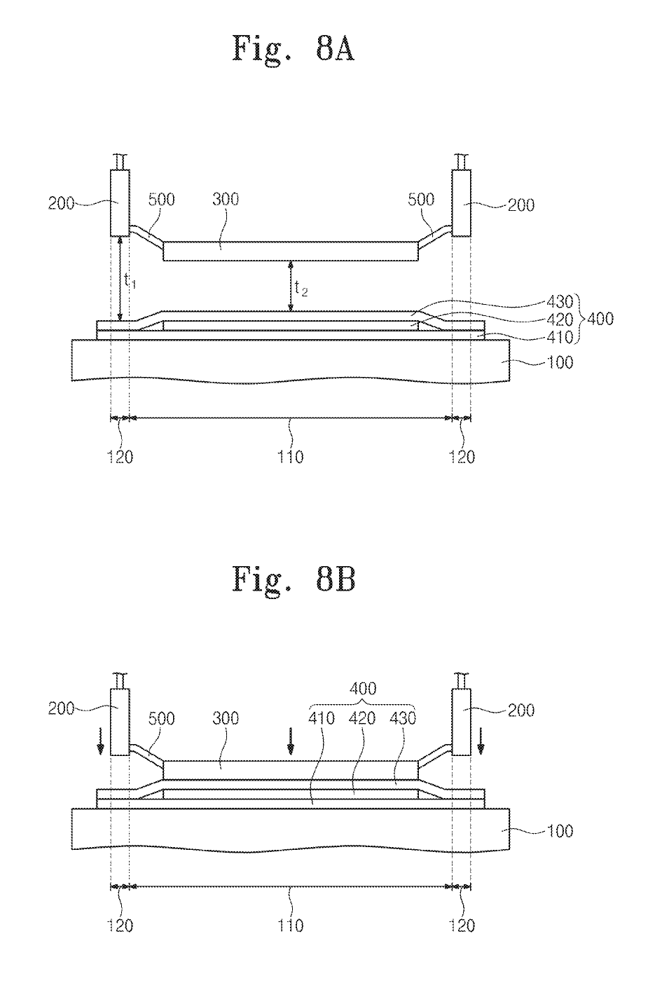

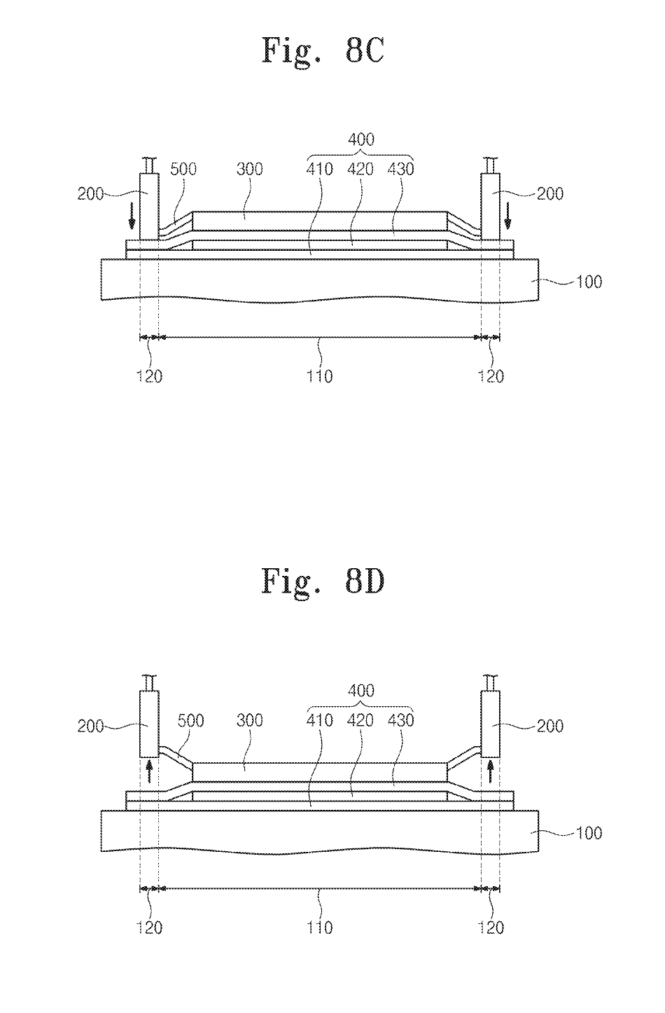

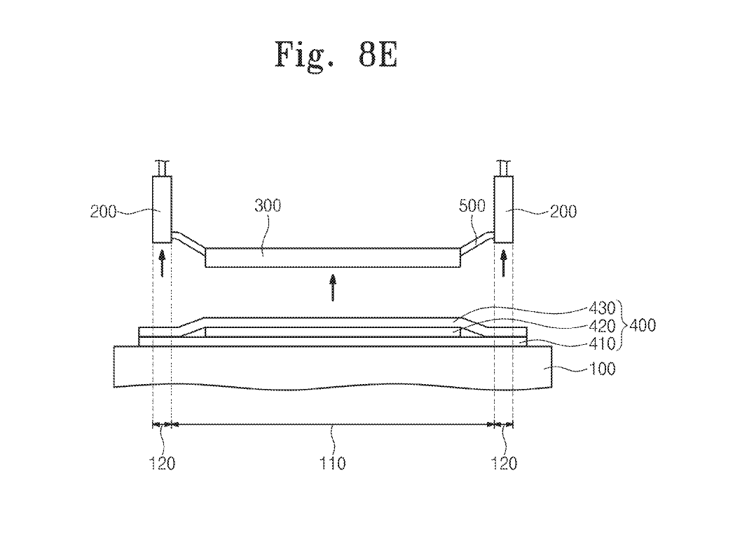

FIG. 6 is a plan view of a press part having a protrusion according to another embodiment. FIG. 7 is a cross-sectional view of the press part of FIG. 6. Referring to FIGS. 6 and 7, a press part 300 includes a protrusion 320 disposed along an edge of a bottom surface of the press part 300 to protrude from the bottom surface of the press part 300 in a direction of a stage 100. Thus, when the press part 300 descends toward a substrate 420, the protrusion 320 contacts a top surface of a donor film 430. In some embodiments, the protrusion 320 closely attaches the donor film 430 to the substrate 420 along an edge of the bottom surface of the press part 300. Thus, permeation of the outgas generated when laminating is performed with a heating bar 200 separating donor film 430 from the substrate 420 may prevented. FIGS. 8A to 8E are cross-sectional views illustrating a laminating process according to another embodiment. In some embodiments, the laminating process according to another embodiment may be the same as that of FIGS. 4A to 4E according to an embodiment.

FIG. 8A is a cross-sectional view illustrating a process of disposing a laminating target film 400 according to another embodiment. Referring to FIG. 8A, a laminating apparatus 1000 further includes a coupling part 500 between the press part 300 and the heating bar 200. In some embodiments, the coupling part 500 has a first end connected to the press part 300 and a second end connected to the heating bar 200 to couple the press part 300 to the heating bar 200 so that the press part 300 and the heating bar 200 are mechanically interlocked.

Since the heating bar 200 and the press part 300 are similar to those of FIG. 4A, their descriptions will be omitted.

In some embodiments, an upper portion of the heating bar 200 is connected to a first moving part (not shown) to move the heating bar 200 so that the heating bar 200 is disposed above the donor film 430. When the heating bar 200 is moved by the first moving part, since the press part 300 is coupled to the heating bar 200 through the coupling part 500, the press part 300 may also be moved together with the heating bar 200.

In some embodiments, the coupling part 500 may set initial positions of the heating bar 200 and the press part 300 so that a distance t2 between a bottom surface of the press part 300 and a top surface of the donor film 430 is less than that t1 between a bottom surface of the heating bar 200 and the top surface of the donor film 430. In some embodiments, the coupling part 500 may set initial positions of the heating bar 200 and the press part 300 so that the distance t2 between the bottom surface of the press part 300 and the top surface of the donor film 430 is equal to that t1 between the bottom surface of the heating bar 200 and the top surface of the donor film 430.

In some embodiments, the coupling part 500 includes a plate spring that is an elastic member deformed by a force provided from the heating bar 200 to apply an elastic force to the press part 300. In some embodiments, the plate spring has a first end connected to a side surface of the press part 300 facing the heating bar 200 and a second end connected to a side surface of the heating bar 200 facing the press part 300. In some embodiments, the elastic member may be modified in shape. In some embodiments, the elastic member may include a coil spring.

FIG. 8B is a cross-sectional view illustrating a pressing process of the pressing part according to another embodiment. FIG. 8C is a cross-sectional view illustrating a thermo-compressive bonding process of the heating bar according to another embodiment. Referring to FIGS. 8B and 8C, when the first moving part (not shown) moves the heating bar 200 downward from the initial position of the heating bar 200, the press part 300 coupled to the heating bar 200 descends from the initial position of the press part 300.

In some embodiments, the bottom surface of the press part 300 contacts the top surface of the donor film 430 before the bottom surface of the heating bar 200 contacts the top surface of the donor film 430 since a distance t2 between the bottom surface of the press part 300 and the top surface of the donor film 430 is less than that t1 between the bottom surface of the heating bar 200 and the top surface of the donor film 430 due to the plate spring, when the first moving part moves the heating bar 200 downward.

In some embodiments, the, the plate spring is gradually pressed by the force provided as the heating bar 200 descends in a direction perpendicular to the top surface of the substrate 420 by the first moving part since the press part 300 contacts and is fixed to the top surface of the donor film 430. Thus, the plate spring applies a gradually increasing elastic force to the press part 300, and the press part 300 applies a gradually increasing pressure to the top surface of the donor film 420 to closely attach the donor film 430 to the substrate 420.

In some embodiments, the bottom surface of the heating bar 200 contacts the top surface of the donor film 430 when the heating bar 200 further descends by the first moving part. Thereafter, the heating bar 200 applies heat and pressure to the top surface of the donor film 430 to thermo-compressively bond the donor film 430 and the lower film 410 which are disposed on the edge area 120.

FIG. 8D is a cross-sectional view illustrating a process of collecting the heating bar according to another embodiment. FIG. 8D is a cross-sectional view illustrating a process of collecting the press part according to another embodiment. Referring to FIGS. 8D and 8E, the heating bar 200 ascends together with the first moving part, and thus, the bottom surface of the heating bar 200 and the top surface of the donor film 430 are separated from each other. In some embodiments, the elastic force of the plate spring may gradually decrease as the heating bar 200 ascends. In some embodiments, the pressure pressing the top surface of the donor film 430 by the press part 300 may gradually decrease. If the heating bar 200 continuously ascends, the bottom surface of the press part 300 and the top surface of the donor film 430 disposed on an area of the substrate are separated from each other, and thus, each of the press part 300 and the heating bar 200 returns to the initial position thereof.

In the laminating apparatus of FIGS. 8A to 8E according to another embodiment, the heating bar 200 and the press part 300 are mechanically interlocked with each other. Thus, when the heating bar 200 is moved, the press part 300 may also be movable. Thus, a separate moving part for moving the press part 300 is not required. Also, a separate process of allowing the press part 300 to approach the donor film 430 is not required. As a result, the laminating apparatus may be simplified in structure and operation.

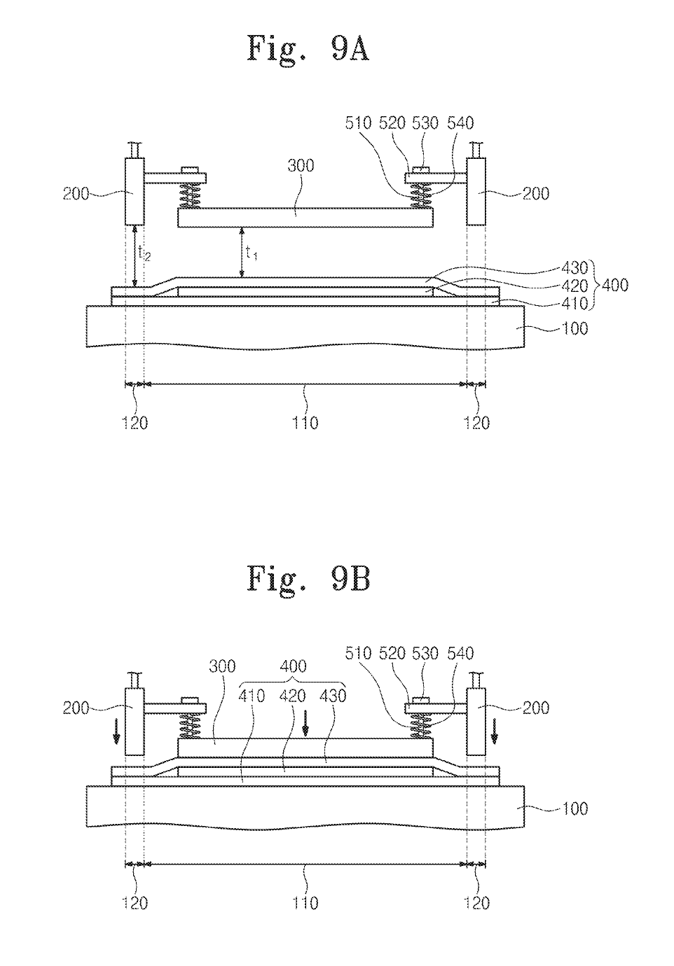

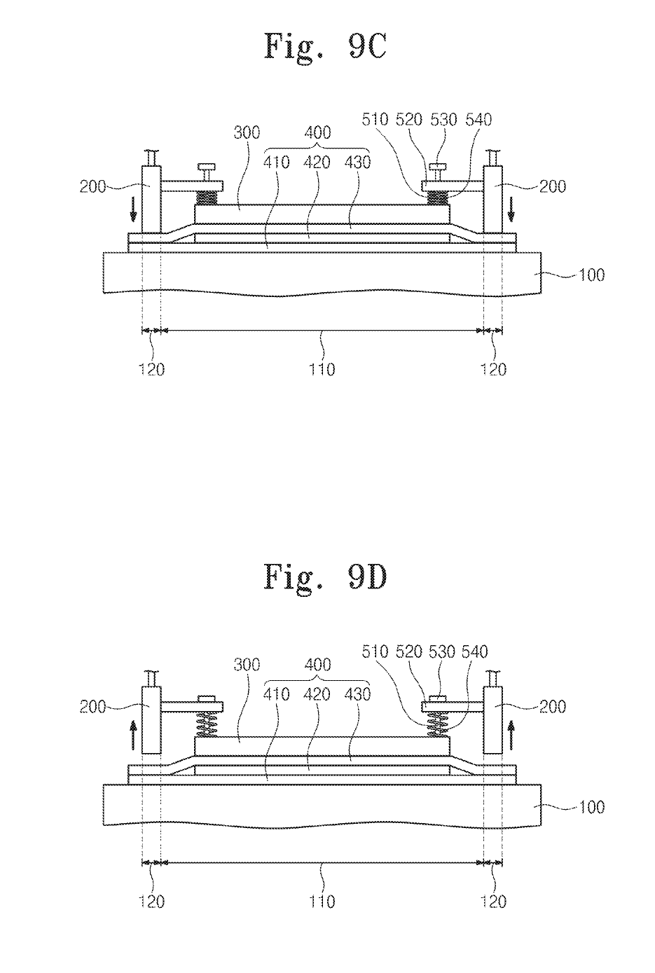

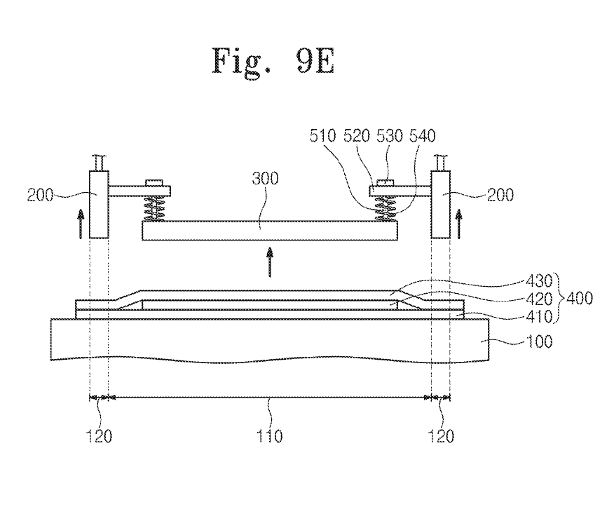

FIGS. 9A to 9E are cross-sectional views illustrating a laminating process according to further another embodiment. The laminating process according to further another embodiment may be the same as that of FIGS. 4A to 4E according to an embodiment.

Referring to FIG. 9A, the laminating apparatus 1000 includes a guiding bar 510 extending vertically from a top surface of a press part 300, a slider 520 extending from a heating bar 200 and coupled to the guiding bar 510 movable in the vertical direction, and a head part 530 disposed on an upper end of the guiding bar 510 to prevent the guiding bar 510 from being separated from the slider 520.

According to an embodiment, a hole (not shown) through which the guiding bar 510 passes is defined in the slider 520. In some embodiments, the head part 530 may have a diameter greater than an inner diameter of the hole so that the head part 530 does not pass through the hole. In some embodiments, the guiding bar 510 may not be separated from the slider 520 by the heat part 530 since the head part 530 is coupled to the upper end of the guiding bar 510 passing through the hole.

In some embodiments, an initial position of each of a heating bar 200 and a press part 300 may be set by a length of the guiding part 510. In some embodiments, the initial position of each of the heating bar 200 and the press part 300 may be set so that a distance t2 between a bottom surface of the press part 300 and a top surface of the donor film 430 is less than that t1 between a bottom surface of the heating bar 200 and the top surface of the donor film 430.

In some embodiments, an elastic member that is deformed by an applied force to apply an elastic force to the press part 300 may disposed between the slider 520 and press part 300. In some embodiments, a coil spring 540 may be disposed between the slider 520 and the press part 300. In some embodiments, the coil spring 540 has an upper end connected to a bottom surface of the slider 520 and a lower end connected to the top surface of the press part 300. In some embodiments, the coil spring 540 may be substituted with other elastic members. In some embodiments, the elastic member may include a plate spring. In some embodiments, the elastic member may be excluded, or the elastic member may be substituted with a hydraulic cylinder.

Since the heating bar 200 and the press part 300 are similar to those of FIG. 4A, their descriptions will be omitted.

In some embodiments, the heating bar 200 has an upper portion connected to a first moving part (not shown). In some embodiments, the slider 520 supports a bottom surface of the head part 530. In some embodiments, the head part 530 prevents the guiding bar 510 from being separated from the slider 520. When the heating bar 200 is moved by the first moving part, since the press part 300 is coupled to the heating bar 200 through the guiding bar 510 and the slider 520, the press part 300 may also be moved together with the heating bar 200.

FIG. 9B is a cross-sectional view illustrating a pressing process of the pressing part according to further another embodiment. FIG. 8C is a cross-sectional view illustrating a thermo-compressive bonding process of the heating bar according to another embodiment. Referring to FIGS. 9B and 9C, when the first moving part (not shown) moves the heating bar 200 downward, the press part 300 coupled to the heating bar 200 descends also. Since a distance t2 between the bottom surface of the press part 300 and the top surface of the donor film 430 is less than that t1 between the bottom surface of the heating bar 200 and the top surface of the donor film 430, when the first moving part moves the heating bar 200 downward, the bottom surface of the press part 300 contacts the top surface of the donor film 430 before the bottom surface of the heating bar 200 contacts the top surface of the donor film 430. In some embodiments, a distance between the bottom surface of the slider 520 and the top surface of the press part 300 may decrease as the heating bar 200 descends by the first moving part. Thus, the coil spring 540 may be gradually pressed by the force provided from the heating bar 200. Thus, the coil spring 540 applies a gradually increasing elastic force to the top surface of the press part 300, and the press part 300 applies a gradually increasing pressure to the top surface of the donor film 420 to closely attach the donor film 430 to the substrate 420.

When the heating bar 200 further descends by the first moving part, the bottom surface of the heating bar 200 and the top surface of the donor film 430 contact the top surface of press part 300. Thereafter, the heating bar 200 applies heat and pressure to the top surface of the donor film 430 to laminate the donor film 430 and the lower film which are disposed on an edge area 120, thereby thermo-compressively bonding the donor film 430 and the lower film 410.

FIG. 9D is a cross-sectional view illustrating a process of collecting the heating bar according to further another embodiment. FIG. 9E is a cross-sectional view illustrating a process of collecting the press part 300 according to further another embodiment. Referring to FIGS. 9D and 9E, the first moving part ascends, and the heating bar 200 is separated from the donor film 430 on the edge area 120 in a state where a pressure is applied to the donor film 420 by the press part 300 to prevent the donor film 430 from being separated from the substrate 420. As the heating bar 200 ascends, a distance between the bottom surface of the slider 520 and the top surface of the donor film 420 gradually increases, and the elastic force of the coil spring gradually decreases. Thus, the pressure pressing the top surface of the donor film 430 by the press part 300 may gradually decrease. If the heating bar 200 ascends, the bottom surface of the press part 300 and the top surface of the donor film 430 are separated from each other, and thus, each of the press part 300 and the heating bar 200 returns to the initial position thereof.

In some embodiments, the laminating apparatus and method may perform the laminating in the state where the donor film and the substrate are closely attached to each other to prevent the transfer layer of the donor film from being contaminated by the outgas generated during the laminating. Thus, the occurrence of the defects of the donor film during the laminating may be prevented to improve the reliability of the laminating process.

While this disclosure has been particularly shown and described with reference to preferred embodiments thereof, it will be understood by those skilled in the art that various changes in form and details may be made therein without departing from the spirit and scope of the invention as defined by the appended claims.

Thus, the invention should not be construed as being limited to the embodiments set forth herein and should be only defined by scopes of claims.

What is claimed is:

1. A laminating method comprising:
providing a laminating apparatus, said apparatus comprising:
a stage, a heating bar, and a press part;
successively disposing a lower film, a substrate, and a donor film on the stage;
applying heat and pressure using the heating bar to an edge of the lower film and an edge of the donor film to thermo-compressively bond the donor film and the lower film so that the substrate is sealed by the lower film and the donor film; and
pressing a top surface of the donor film by using the press part so that the thermo-compressive bonding is performed in a state where the donor film is closely attached to the substrate.

2. The laminating method of claim 1, wherein the pressing of the top surface of the donor film by using the press part is performed for a time comprising a time for which the heating bar performs the thermo-compressive bonding.

3. The laminating method of claim 1, wherein the pressing of the top surface of the donor film by using the press part is performed from a starting time of the thermo-compressive bonding of the heating bar to an ending time of the thermo-compressive bonding.

4. The laminating method of claim 1, wherein the apparatus further comprises a vacuum chamber:
where the lower film, the substrate, the donor film, heating bar, and the press part are disposed in the vacuum chamber;
vacuum-exhausting the vacuum chamber to make the inside of the vacuum chamber in a vacuum state between the successively disposing of the lower film, the substrate, and the donor film and the thermo-compressively bonding of the donor film and the lower film; and
venting the vacuum chamber so that the donor film is attached to the substrate after the pressing of the top surface of the donor film.
